(19) United States
(12) Patent Application Publication
(10) Pub. No.: US 2018/0086671 A1
(43) Pub. Date: Mar. 29, 2018

(54) ARTIFICIAL STONE COMPRISED OF WASTE PLASTIC MATERIALS

(71) Applicant: ARQLITE SPC, Seattle, WA (US)

(72) Inventor: Sebastian SAJOUX, Buenos Aires (AR)

(73) Assignee: ARQLITE SPC, Seattle, WA (US)

(21) Appl. No.: 15/564,645

(22) PCT Filed: Apr. 8, 2016
(86) PCT No.: PCT/US2016/026691

§ 371 Date: Oct. 5, 2017

Related U.S. Application Data
(60) Provisional application No. 62/145,653, filed on Apr. 10, 2015.

(51) Int. Cl. C04B 30/00; C04B 18/20; C04B 14/06; C04B 18/02; C08J 11/06; B29C 47/00; B29B 13/10; B29B 7/00; B28C 5/00; B28B 3/20; E01C 3/00

(52) U.S. Cl. CPC C04B 30/00; C04B 18/20; C04B 14/06; C04B 18/027; C08J 11/06; B29C 47/0004; C04B 2111/0075; B29B 7/002; B29C 47/0066; B28C 5/003; B28B 3/20; E01C 3/003; B29B 13/10

(57) ABSTRACT

Disclosed herein is an artificial stone comprised of a first waste plastic material and a second waste plastic material, wherein the first and/or second waste plastic material is a non-recyclable or a recyclable plastic material. A method of manufacturing the artificial stone is also disclosed. The artificial stone may be used, for example, as an aggregate in a concrete mix or as a filler on a road laying base or sub-base.

### FIELD OF THE INVENTION

The present invention relates to the field of construction and materials used in this activity, in particular it relates to the preparation of concrete mixtures, even more particularly it relates to the materials used as aggregates in concrete mixtures or as fillers to form a base or sub-base on road laying.

### PRIOR ART

Concrete is a composite material used in construction, consisting essentially of a binder with the addition of inert particles or component fragments or aggregates, water and certain specific additives depending on the type of the desired final mixture to be obtained.

The main binder is cement mixed with a suitable proportion of water to produce and hydration reaction. The aggregate particles are classified into gravel, little gravel and sand depending mainly on their average diameter. The cement mixture with sand and water without other aggregates constitutes a mortar.

Cement is a powder material that is not a binder itself, but when mixed with water hydrates making a moldable paste that has adhesive properties and in a few hours hardens turning into a material of stony consistency. The cement consists essentially of hydrated calcium silicate, being responsible for the adhesive characteristics it shows. To modify some of its characteristics or behavior usually additives are added, typically in an amount less than 1% of the total mass of concrete, and there is a wide variety of them consisting of: dyes, accelerators, cure retardants, flow agents, sealants, fibers, among most significant.

The main structural feature of concrete is that it resists very well compression stresses, but it does not show a good behavior against other stresses such as tensile, bending, shear, etc., for this reason it is commonly used associated with certain steel load bearing elements, receiving the name of reinforced concrete or previously reinforced concrete; performing very favorably to the various stresses. When a reinforced concrete structure is projected dimensions of the elements, type of concrete, additives and steel to be used depending on the efforts to support and the environmental conditions to be exposed to are established.

At the end of XX century, concrete becomes the most used material in construction. It is shaped by the use of rigid molds called formwork. Its use is common in buildings, bridges, dams, ports, canals, tunnels, etc. Even in those buildings which main structure is made of steel, their use is essential to form the foundation. There are a variety of concretes they have been developed for various purposes, such as concrete reinforced with glass fibers, lightweight air entrained cellular concrete, lightweight natural fiber concrete, self-compacting concrete.

The most important arid in the product is sand, as it is not possible to make good concrete without good sand. Best sands are from rivers, which are usually pure quartz, ensuring strength and durability.

With natural arids as boulders, concretes are more workable and require less mixing water than grinding arids.

The higher the maximum arid size is, the lower the needs of cement and water are, but said maximum size is limited by the minimum dimensions of the element to build or separation between frames, as these gaps should be filled by concrete and therefore by larger arids.

In a mixture of arids high agglutination is one that leaves few gaps, which is achieved with lean sand mixtures and a high ratio of coarse arids, requiring little mixing water, being difficult to compact the concrete, but having the means to this end, very resistant concretes are obtained. As regards the content fine grains, they make the mixture more but require more mixing water and cement. In each case a compromise formula taking into account the various factors is needed.

An arid commonly used as low density coarse aggregate is clay expanded by heating, commercially known as LECA (Lightweight Expanded Clay Aggregate). It has the disadvantage that if concrete is pumped, the LECA fractures and dispersion of the same is affected.

Another aggregate that lightens final structures is expanded polystyrene. This load greatly reduces the strength of concrete so its use is very limited. It also increases the cost of concrete, so it is used only in specific cases.

Therefore, there is a need for new materials that can be used as aggregates, either alone or mixed with known compounds to obtain different concretes with various qualities and benefits.

In particular, the characteristics of concrete and large volumes used worldwide, allow the incorporation of materials not used in construction, dispersed in very low ratios without affecting the mixture. Using a new type of aggregate totally or partially manufactured from waste plastic materials and/or virgin plastic materials allows producing certain benefits to the mixture, such as lower weight and greater insulating capacity, less water absorption than mineral aggregates, as well as a lower expansion factor and pumping resistance, characteristics necessary in the construction of buildings using concrete. Also, the use of waste allows at the same time reducing pollution by including disposed materials in great amounts.

The new more sustainable building systems require more efficient materials to achieve a better acoustic and thermal insulation, lower weight of the structure and produced from recovered materials such as waste recovered plastics. All the above features add LEED points (acronym for Leadership in Energy & Environmental Design). LEED is a certification system for sustainable buildings, developed by the US Green Building Council. It was first introduced in 1998, and used in several countries since then, and consists of a set of rules on the use of strategies for sustainability in buildings of all kinds. Certification is voluntary and aims to promote the use of strategies that enable an overall improvement in the environmental impact of the construction industry.

### SUMMARY OF THE INVENTION

Therefore, it is an object of this invention an artificial stone to be employed in the preparation of concrete as aggregate or as filler to form a base or sub-base on road laying in the form of separate and individual substantially spherical, polyhedral or cylindrical solid units, and mainly composed by waste plastic materials and/or virgin plastic materials, wherein the waste plastic materials are non-recyclable plastic materials selected from multilaminates, aluminized plastic materials, unidentified plastics and mixtures thereof.

Preferably, each of said units is divided into two portions, an upper portion and a lower portion, by means of a circular shoulder on the middle portion. Also, preferably, the substantially polyhedral units comprise a plurality of faces, preferably from 4 faces to about 34 faces, wherein each of said units is divided in two portions, and upper and a lower portion, by a circular shoulder on its middle portion.

Preferably, the substantially cylindrical units comprise longitudinal grooves dug in parallel on the side surface.

More preferably, the substantially cylindrical units comprise spiral transverse grooves dug in parallel on the side surface.

Preferably, the artificial stone is mainly comprised at least one or more plastic materials selected from polyethylene terephthalate (PET), high density polyethylene (HDPE), (poly) vinyl chloride (PVC), low density polyethylene (LDPE), polypropylene (PP), polystyrene (PS) and aluminized plastic.

More preferably, the composition of the artificial stone comprises: PET from 0 to about 50% by weight, HDPE from 0 to about 70% by weight, PVC from 0 to about 70% by weight, LDPE from 0 to about 70% by weight, PP from 0 to about 70% by weight, PS from 0 to about 70% by weight, aluminized plastics from 0 to about 30%, being all the percentages expressed by weight of the final composition.

In a preferred embodiment, each of said units of the artificial stone has a weight ranging from about 2 to about 20 grams, and a volume between about 5 cm³ and about 10 cm³.

Also preferably, each of said units of the artificial stone is coated with a layer of fine arids selected from sand, crushed stone, crushed rubble, and mixtures thereof.

Most preferably, each of said units of the artificial stone is coated with a layer of cement over the layer of fine arids.

It is another object of this invention a process for manufacturing an artificial stone to be employed in the preparation of concrete as aggregate or filler to form a base and/or sub-base on road laying comprising the steps of:

a. grinding plastic waste separately with a mill for plastics with a sieve allowing the passage of particles from about 5 mm to about 50 mm,

b. mixing the ground waste in the specified ratios,

c. extruding the mixture at medium temperature without melting in the form of a square rod or continuous material with a thickness from about 1.27 cm (½ inch) to about 5.08 cm (2 inches) and a width determined by the number of installed cutting molds,

d. molding by cutting and pressure the units of artificial stone at medium temperature with a rotating mold or press system,

e. cooling the units obtained, and

f. packing in suitable containers for shipping and commercialization.

Incidentally, before step a. grinding, the process comprises the initial steps of:

i. classifying the waste material,

ii. washing the classified material,

iii. drying the washed material.

Step c) extruding and step d) molding of the process are performed at a temperature between about 140° C. and about 300° C.

Alternatively, step c) extruding of the process comprises: c.1) extruding the mixture at medium temperature without reaching melting as a cylindrical continuous rod with longitudinal or transverse spiral grooves.

Also alternatively step c) extruding of the process comprises c.1′) extruding the mixture at medium temperature without reaching melting as a continuous faceted rod of 3 to 32 faces with longitudinal or transverse spiral grooves.

Furthermore, step d) molding by cutting of the process comprises d.1) cutting the continuous rod at medium temperature with a cutting blade with plain or serrated edge.

Still alternatively, before step d.1) of cutting, the rod is subjected to bombardment with fine aggregates selected from sand, crushed stone, crushed rubble, and mixtures thereof.

Incidentally, before step e) cooling of the process, the artificial stone units are subjected to stirring and/or bombardment with fine aggregates selected from sand, crushed stone, crushed rubble, and mixtures thereof.

In a preferred form, step e) cooling the units obtained is by immersion in water, drainage and subsequent air drying at room temperature.

In an alternative to step e) cooling of the process, the artificial stone units are coated with a cement slurry and dried in air at room temperature.

### BRIEF DESCRIPTION OF THE DRAWINGS

FIG. 1A shows a perspective isometric view of a preferred embodiment of a unit of artificial stone according to this invention, substantially cylindrical with longitudinal grooves on the side surface.

FIG. 1B shows a perspective isometric view of the preferred embodiment of a unit of artificial stone according to FIG. 1A, coated by a fine arid material adhered to its surface.

FIG. 1B shows a perspective isometric view of the preferred embodiment of a unit of artificial stone according to FIG. 1B, coated by a cement layer.

FIG. 2 shows a perspective isometric view of another preferred embodiment of a unit of artificial stone according to this invention, having a polyhedral configuration substantially as a dodecahedron (12 faces) with a central perimetral shoulder.

FIG. 3 shows a perspective isometric view of still another preferred embodiment of a unit of artificial stone according to this invention, having a spherical configuration with a central perimetral shoulder.

FIG. 4A shows a perspective isometric view of still another preferred embodiment of a unit of artificial stone according to this invention, having a cylindrical configuration which front and rear faces are provided with grooves as being cut with a serrated edge.

FIG. 5 shows a ground plastic particulate material for use as an artificial aggregate of fine particle size (less than 5 mm particle size) which may be incorporated as an aggregate in concrete formulations.

FIG. 6A shows a perspective isometric view of still another additional preferred embodiment of a unit of artificial stone according to this invention, of polyhedral configuration with 6 side faces which front and rear faces are smooth as being cut with a plain edge.

FIG. 6B shows a perspective isometric view of still another preferred embodiment of a unit of artificial stone according to this invention, of polyhedral configuration with 6 side faces which front and rear faces have grooves as being cut with a serrated edge.

FIG. 7 shows a perspective isometric view of still another preferred embodiment of a unit of artificial stone according to this invention, of substantially cylindrical configuration with transverse spiral grooves on the side surface.

FIG. 8 shows a perspective isometric view of still another preferred embodiment of a unit of artificial stone according to this invention, having a polyhedral configuration with 4 side faces and which front and rear faces have grooves as being cut with a serrated edge.

FIG. 9 shows a cross section of a concrete specimen wherein artificial stone units according to this invention can be observed, used as an aggregate to its composition.

FIG. 10 shows a road laying profile, wherein to form the base and sub-base it was used a bed of units of artificial stone according to this invention.

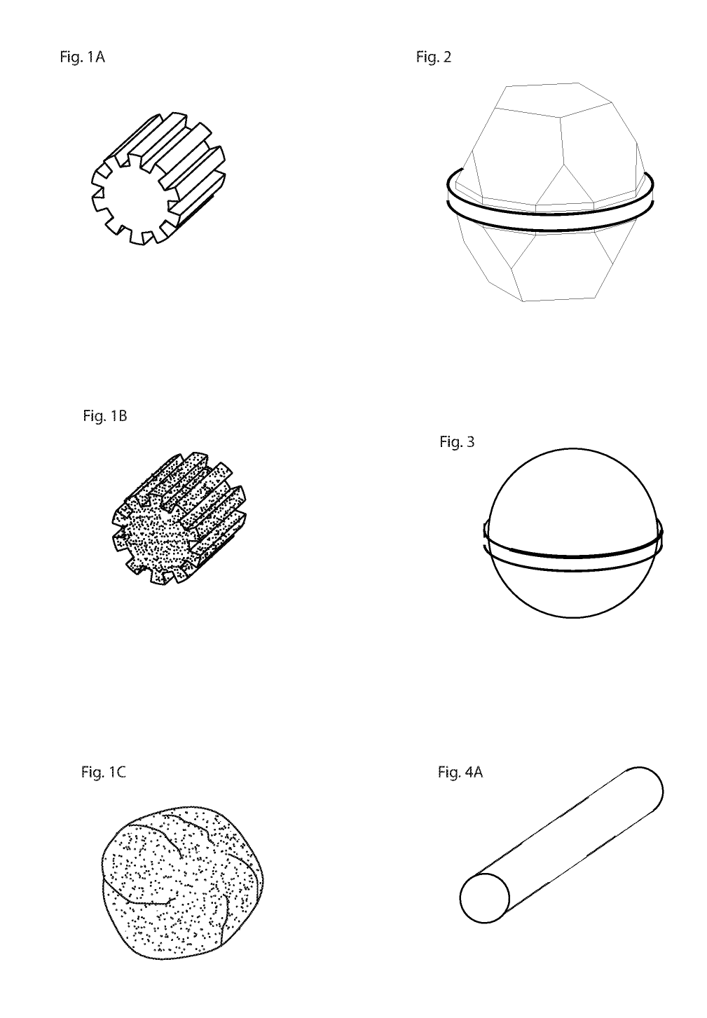

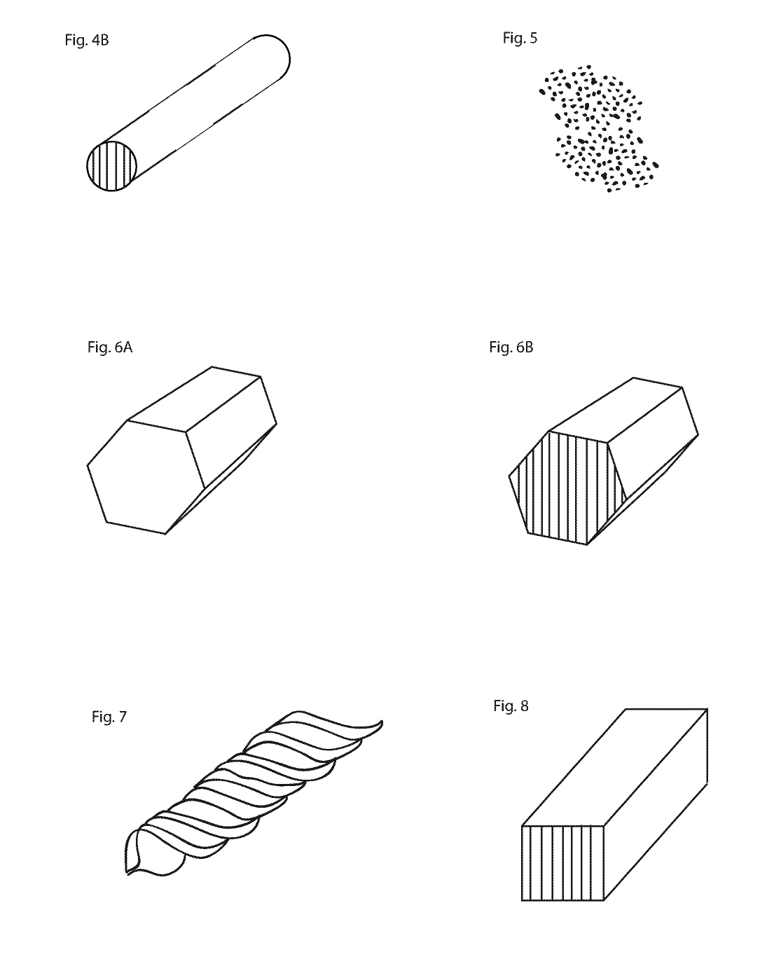

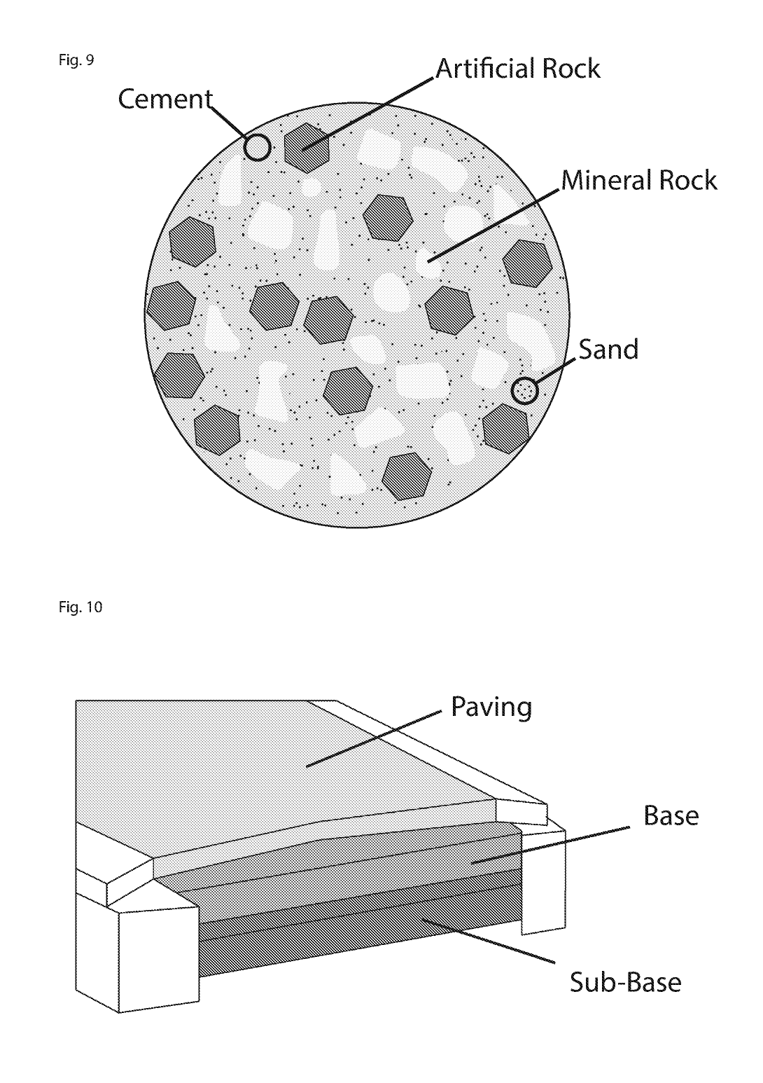

### DETAILED DESCRIPTION OF THE INVENTION

With the purpose of providing viable alternatives to the technical problem, it is proposed an artificial stone to be employed in the preparation of concrete as aggregate, or as a filler to form a base and/or sub-base on road laying that it is presented in the form of separate and individual substantially spherical, polyhedral or cylindrical solid units, and mainly composed by waste plastic materials and/or virgin plastic materials, wherein the waste plastic materials are non-recyclable plastic materials selected from multilaminates, aluminized plastic materials, unidentified plastics and mixtures thereof.

Preferably, each of said artificial units is divided into two portions, an upper portion and a lower portion, by means of a circular shoulder on the middle portion.

The artificial stone according to this invention can be presented in substantially polyhedral solid separate and individual units comprising a plurality of faces, preferably from 4 faces to about 34 faces (triacontakaitetragon), wherein each of said units is divided in two portions, and upper and a lower portion, by a circular shoulder on its middle portion.

The higher the number of faces of the units, the shape gradually tends to be substantially spherical, that is two hemispheres separated by a circular shoulder on its middle portion.

In a preferred embodiment, the units have a substantially cylindrical shape comprising longitudinal grooves dug in parallel on the side surface.

In another preferred embodiment, the substantially cylindrical units comprise spiral transverse longitudinal grooves dug in parallel on the side surface.

Irregularities provided by the different possible shapes, especially longitudinal or substantially transverse grooves or a shoulder occurring in the middle portion or equator of each unit, as the porosity of the final product, facilitate anchoring with concrete facilitating their inclusion. In particular, the circular shoulder allows gripping in the concrete.

Additionally and preferably, in order to improve adherence of the cement to the surface of each of said units of artificial stone, it is covered by a layer of fine arids selected from sand, crushed stone, crushed rubble, and mixtures thereof. Even more preferably, each of said units of artificial stone is covered by a layer of cement over the layer of fine arids further facilitating gripping of the cement.

Also, the variety of shapes and sizes is important for best performance of the artificial stones in combination with concrete. Like natural stones that vary in size and shape, the same happens with this product.

This artificial stone can replace all or part of the natural stone or leca in a concrete mixture. The amount present in the concrete mixture depends on the final and desired properties and characteristics as to density, compressive strength, weight of the structure, drainage, etc.

This artificial stone is about 60% lighter than crushed stone, therefore it lightens the final structures obtained with the concrete containing the same and also has the benefit of being pumped without breaking the constituents units as with leca.

Concrete prepared with artificial stone according to this invention used as aggregate can be pumped maintaining an even distribution of the same in the cement mixture.

Also, having an expansion and shrinkage factor lower than stone to extreme temperature changes, its presence produces less pressure on the concrete protecting it from abrupt temperature variations.

The artificial stone of this invention is mainly composed of recyclable and non-recyclable plastic materials, polymers, copolymers and terpolymers such as multilaminates, aluminized plastic materials, unidentified plastics and the like.

Due to the intrinsic properties of plastic materials, artificial stone according to this invention does not absorb moisture, thus avoiding the need to keep it hydrated as traditional aggregates. This fact improves the hardness of concrete as it is required less water for manufacturing the same.

In this way, the units of artificial stone according to this invention are manufactured from one or more plastic materials that can be new or mainly from waste generated in various industries and due to their multilayer nature cannot be recycled as virgin matter again. Waste plastics from cities are also used after conditioning the same. That is, they must be sorted, washed, dried and grounded separately.

The main plastic materials which can be employed, without limitation, are: polyethylene terephthalate (PET), high density polyethylene (HDPE), (poly) vinyl chloride (PVC), low density polyethylene (LDPE), polypropylene (PP), polystyrene (PS) and aluminized plastics.

Therefore, in a preferred embodiment of this invention, the artificial stone to be employed in the preparation of concrete as aggregate or as a filler to form a base or sub-base on road laying, is mainly comprised of at least one of the following virgin, residual or waste plastic material: polyethylene terephthalate (PET), high density polyethylene (HDPE), (poly) vinyl chloride (PVC), low density polyethylene (LDPE), polypropylene (PP), polystyrene (PS) and aluminized plastics.

Preferably, the amount of each of said waste plastic material in the composition of artificial stone is: PET from 0 to about 50% by weight, HDPE from 0 to about 70% by weight, PVC from 0 to about 70% by weight, LDPE from 0 to about 70% by weight, PP from 0 to about 70% by weight, PS from 0 to about 70% by weight, aluminized plastics from 0 to about 30%, being all the percentages expressed by weight of the final composition.

Each unit of the artificial stone has a weight ranging from about 2 to about 20 grams. For example, in a preferred embodiment of the invention, the units of artificial stone are spheres from about 5 cm³ to about 10 cm³ by volume as well as 22 sided polyhedrons (icosahedron) also from about 5 cm³ to about 10 cm³ by volume. Thus, by the difference in size, shape and faces of the units it is optimized the granulometry of the mixture with the remaining materials to obtain concrete.

It is another object of this invention a process for manufacturing an artificial stone to be employed in the preparation of concrete as aggregate, or as a filler to form a base or sub-base on road laying, comprising the steps of:

a. grinding plastic waste separately with a mill for plastics with a sieve allowing the passage of particles from about 5 mm to about 50 mm,

b. mixing the ground waste in the specified ratios,

c. extruding the mixture at medium temperature without melting in the form of a square rod or continuous material with a thickness with a thickness from about 1.27 cm (½ inch) to about 5.08 cm (2 inches) and a width determined by the number of installed cutting molds,

d. molding by cutting and pressure the units of artificial stone at medium temperature with a rotating mold or press system,

e. cooling the units obtained, and

f. packing in suitable containers for shipping and commercialization.

Furthermore, when plastics used are, for example, waste or plastic waste from cities, before step a) grinding, the process comprises the initial steps of:

i. classifying the waste material,

ii. washing the classified material,

iii. drying the washed material.

While none of these plastics are pure but come from composite laminates, which therefore cannot be subjected to traditional recycling system, classification involves the identification, evaluation and weighted estimate of the different types of plastic materials used as raw material to proceed to the subsequent mixing within the desired parameters.

Washing of material must be performed to remove debris that may affect the mixture with cement to form, for example, concrete, such as sugars, fats, detergents and other products that have been contained, for example, in the recovered plastic containers.

Those plastics that cannot be classified effectively are added to the mixture in small proportions as additional aggregates.

Preferably, step c) extruding and step d) molding of the process are performed at a temperature from about 140° C. to about 300° C. The temperature is adjusted according to the plastics involved and their proportions in the mixture, because the different plastic materials have there own melting temperatures. During the process for manufacturing the units of artificial stone, working temperatures are set to achieve the suitable consistency of the processed mixture.

Alternatively, step c) extruding of the process comprises: c.1) extruding the mixture at medium temperature without melting in the form of a continuous cylindrical rod with longitudinal or transverse spiral grooves. In particular, to form the spiral transverse grooves the rod is rotated through the die.

Also alternatively step c) extruding of the process comprises c.1′) extruding the mixture at medium temperature without melting as a continuous faceted 3 to 32 face rod with longitudinal or transverse spiral grooves.

Furthermore, during step d) molding by cutting of the process comprises d.1) cutting the continuous rod as it is formed through the die at medium temperature with a plain or serrated edge. In particular, the serrated edge produces grooves on the front and rear faces of each unit of artificial stone improving the adherence of cement thereon.

Still alternatively, before step d.1) cutting, the rod is subjected to bombardment with fine arids selected from sand, crushed stone, crushed rubble, and mixtures thereof. Once fine arids are adhered to the rod, it is cut to the desired size units providing units of artificial stone with an improved surface for anchoring cement.

Incidentally, before step e) cooling of the process, the units of artificial stone are subjected to stirring and/or bombardment with fine arids selected from sand, crushed stone, crushed rubble, and mixtures thereof. To this end a flat or circular sieve can be used where the units of artificial stone are mixed and stirred with fine aggregates. Due to the temperature of the units of artificial stone, aggregates adhere to the surface creating a better grip for cement. Alternatively or incidentally, units of artificial stone can be bombarded with fine arids to achieve greater penetration and adhesion.

Preferably, step e) cooling the units obtained is by immersion in water, subsequent drainage and air drying at room temperature. Whether the units of artificial stone have a layer of fine arids or not on their surface, they can be cooled by immersion in water, subsequent drainage and dried in air or by a stream of air, for example at room temperature, in motion or not.

Alternatively to step e) cooling of the process, units of artificial stone are coated with a cement slurry and air dried at room temperature. Units of artificial stone coated with arids and an additional layer of cement can be obtained by placing the units coated with fine arids and a cement slurry into a mixer, forming an external cement layer. Thus, the units of artificial stone have a gray irregular appearance due to the cement producing a more compatible and better adhesion surface with the materials used to manufacture concrete.

1-20. (canceled)

21. An artificial stone, comprising a first waste plastic material and a second waste plastic material;
wherein each artificial stone has a density between about 0.4 grams/cm³ and about 2 grams/cm³; and
is porous.

22. The artificial stone of claim 21, wherein the first waste plastic material and/or the second waste plastic material is a non-recyclable plastic material.

23. The artificial stone of claim 21, wherein the first waste plastic material and/or the second waste plastic material is a recyclable plastic material.

24. The artificial stone of claim 22, wherein the non-recyclable plastic material is selected from the group consisting of a multilaminate, aluminized plastic material, unidentified plastic and mixtures thereof.

25. The artificial stone of claim 21, wherein the artificial stone further comprises virgin plastic material.

26. The artificial stone of claim 21, wherein the first waste plastic material and/or the second waste plastic material are selected from the group consisting of polyethylene terephthalate (PET), high density polyethylene (HDPE), (poly) vinyl chloride (PVC), low density polyethylene (LDPE), polypropylene (PP), and polystyrene (PS).

27. The artificial stone of claim 25, wherein the virgin plastic material is selected from the group consisting of polyethylene terephthalate (PET), high density polyethylene (HDPE), (poly) vinyl chloride (PVC), low density polyethylene (LDPE), polypropylene (PP), and polystyrene (PS).

28. The artificial stone of claim 21, wherein the artificial stone has been extruded.

29. The artificial stone of claim 21, wherein the artificial stone has a weight from about 2 grams to about 20 grams.

30. The artificial stone of claim 21, wherein the artificial stone is about 60% lighter than crushed stone.

31. The artificial stone of claim 21, wherein the artificial stone has a volume from about 5 cm³ to about 10 cm³.

32. The artificial stone of claim 21, wherein the artificial stone is substantially spherical, substantially polyhedral, or substantially cylindrical.

33. The artificial stone of claim 21, wherein the artificial stone is amorphous.

34. The artificial stone of claim 21, wherein the artificial stone is coated with fine aids selected from the group consisting of sand, crushed stone, crushed rubble, and mixtures thereof.

35. The artificial stone of claim 34, wherein the fine aids are coated with cement.

36. A method of producing an artificial stone, comprising:
(a) providing a first waste plastic material and a second waste plastic material;
(b) grinding the first waste plastic material;
(c) grinding the second waste plastic material;
(d) mixing the first waste plastic material and the second waste plastic material, thereby generating a mixture; and
(e) extruding the mixture at a temperature between about 140° C. to about 300° C. to produce the artificial stone,
wherein each artificial stone has a density between about 0.4 grams/cm³ and about 2 grams/cm³; and
is porous.

37. The method of claim 36, further comprising the step of (f) cutting the extruded mixture to produce the artificial stone.

38. A concrete mix, comprising:
(a) an artificial stone;
(b) cement;
(c) mineral rock; and
(d) sand;
wherein the artificial stone comprises a first waste plastic material and a second waste plastic material.

39. The concrete mix of claim 38, further comprising natural stone or lightweight expanded clay aggregate (LECA).

40. The concrete mix of claim 38, wherein the artificial stone has a density between about 0.4 grams/cm³ and about 2 grams/cm³.

41. A road laying base or sub-base, comprising an artificial stone; wherein the artificial stone comprises a first waste plastic material and a second waste plastic material.

42. The road laying base or sub-base of claim 41, wherein the artificial stone has a density between about 0.4 grams/cm³ and about 2 grams/cm³.
